(19) United States
(12) Patent Application Publication
(10) Pub. No.: US 2026/0351226 A1
(43) Pub. Date: Nov. 5, 2026

(54) AUDIO DEVICE, AUDIO DEVICE CONTROL METHOD, AND PROGRAM

(71) Applicant: AlphaTheta Corporation, Yokohama-shi, Kanagawa (JP)

(72) Inventors: Kenta Sagawa, Yokohama-shi, Kanagawa (JP); Nao Takagi, Yokohama-shi, Kanagawa (JP)

(21) Appl. No.: 19/486,167

(22) PCT Filed: May 25, 2023
(86) PCT No.: PCT/JP2023/019546

§ 371 Date: Nov. 20, 2025

(51) Int. Cl. G10H 1/00; G10H 1/40

(52) U.S. Cl. CPC G10H 1/0091; G10H 1/40; G10H 2210/076; G10H 2210/385

(57) ABSTRACT

An acoustic apparatus includes a rotary operator. The rotary operator is adjustable stepwise to a plurality of predetermined scales and sets a time interval used when adding a sound effect or a special effect to audio data. The acoustic apparatus includes: a detector for detecting a rotation angle of the rotary operator; and a determination unit for determining the time interval corresponding to each of the scales in units of multiples of m/n beats of the audio data, depending on BPM of the audio data.

### TECHNICAL FIELD

The present invention relates to an acoustic apparatus, a control method of the acoustic apparatus, and a program.

### BACKGROUND ART

In an acoustic apparatus such as a mixer used for DJ performances and the like, so-called effect processing is known in which sound effects or special effects are added to audio data. In such effect processing, it may be necessary to set a time interval related to effect processing.

For example, in a mixer described in Non-Patent Literature 1, the above-mentioned time interval is set using an operator as illustrated in FIG. 5. The operator illustrated in FIG. 5 includes a button group 101 for setting a multiplication of beats for synchronizing effect sounds, and a rotary operator 102 for adjusting temporal parameters. By independently or sequentially operating these operators, the time interval related to effect processing is set.

### CITATION LIST

### Non-Patent Literature(S)

Non-Patent Literature 1: DJM-900NXS2 User Manual (AlphaTheta Corporation), https://www.pioneerdj.com/ja-jp/support/documents/archive/ddj-sz/#manual

### SUMMARY OF THE INVENTION

### Problem(s) to be Solved by the Invention

In setting the time interval related to effect processing described above, the button group 101 and the rotary operator 102 are different from each other in operation methods and setting targets, and each need to be operated separately.

Therefore, an object of the invention is to provide an acoustic apparatus, a control method of the acoustic apparatus, and a program, allowing for simple and intuitive operations and high setting flexibility in setting the time interval related to effect processing.

### Means for Solving the Problem(s)

[1] An acoustic apparatus including a rotary operator, the rotary operator configured to be adjustable stepwise to a plurality of predetermined scales and configured to set a time interval used when adding a sound effect or a special effect to audio data, the acoustic apparatus including: a detector configured to detect a rotation angle of the rotary operator; and a determination unit configured to determine the time interval corresponding to each of the scales in units of multiples of m/n beats of the audio data, depending on BPM of the audio data.
[2] The acoustic apparatus according to [1], in which the rotary operator is configured to be continuously adjustable in a range other than the plurality of predetermined scales, and the determination unit is configured to determine the time interval corresponding to the range in accordance with the time intervals corresponding to the scales adjacent to the range.
[3] The acoustic apparatus according to [1], in which the determination unit is configured to determine the time interval corresponding to each of the scales to be shorter as a value of the BPM increases, and determine the time interval corresponding to each of the scales to be longer as the value of the BPM decreases.
[4] A control method of an acoustic apparatus, the acoustic apparatus including a rotary operator, the rotary operator being adjustable stepwise to a plurality of predetermined scales and configured to set a time interval used when adding a sound effect or a special effect to audio data, the control method including: detecting a rotation angle of the rotary operator; and determining the time interval corresponding to each of the scales in units of multiples of m/n beats of the audio data, depending on BPM of the audio data.
[5] A program causing a computer to operate as an acoustic apparatus, the acoustic apparatus including a rotary operator, the rotary operator being adjustable stepwise to a plurality of predetermined scales and configured to set a time interval used when adding a sound effect or a special effect to audio data, the acoustic apparatus including: a detector configured to detect a rotation angle of the rotary operator; and a determination unit configured to determine the time interval corresponding to each of the scales in units of multiples of m/n beats of the audio data, depending on BPM of the audio data.

### BRIEF DESCRIPTION OF DRAWINGS

FIG. 1 is a top view illustrating a structure of a DJ mixer according to an exemplary embodiment of the invention.

FIG. 2 illustrates an effect time setter in the exemplary embodiment of the invention.

FIG. 3 is a functional block diagram of a control unit of the DJ mixer in the exemplary embodiment of the invention.

FIG. 4 is a flowchart of a control method in the exemplary embodiment of the invention.

FIG. 5 illustrates a typical acoustic apparatus.

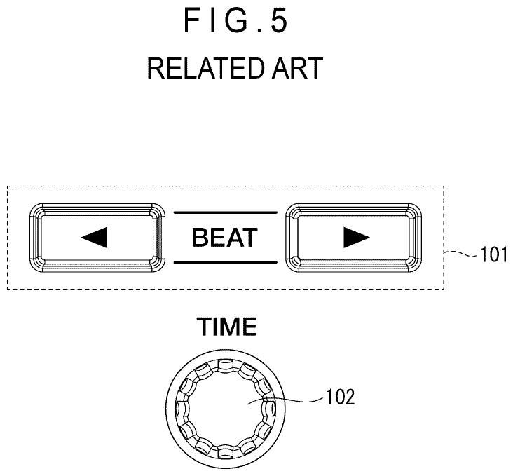

### DESCRIPTION OF EMBODIMENT(S)

An exemplary embodiment of the invention will be described below with reference to the attached drawings.

### Overall Configuration

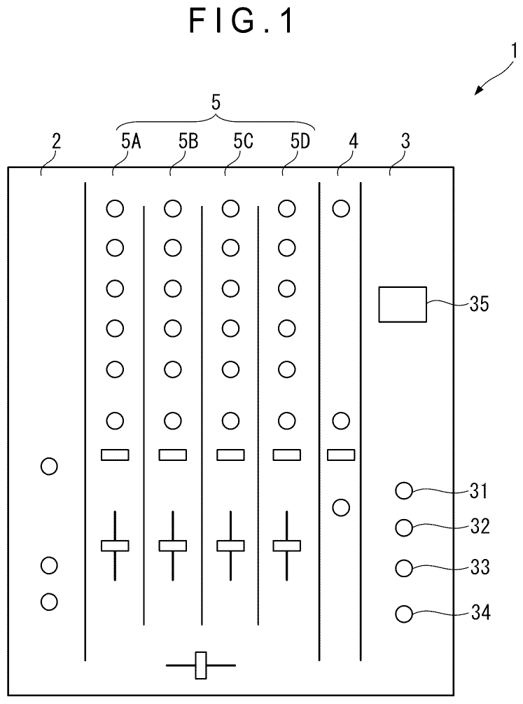

FIG. 1 is a schematic diagram of a DJ mixer 1, which is an acoustic apparatus according to a first exemplary embodiment of the invention. Although not illustrated, on the input side of the DJ mixer 1, music playback apparatuses for playing back music data, such as a vinyl record player, a CD player, and a computer, as well as music operation apparatuses such as a DJ controller, are connected. On the output side of the DJ mixer 1, acoustic apparatuses such as speakers are connected.

Music data, in the form of audio signals played back by music playback apparatuses and music operation apparatuses, is input to the DJ mixer 1 as the acoustic apparatus, and the DJ mixer 1 performs effect processing on audio data of the music data input. Further, the DJ mixer 1 amplifies the audio data on which effect processing has been performed, converts the amplified audio data into analog signals, and then outputs the sound through acoustic apparatuses.

The DJ mixer 1 includes a microphone adjustment unit 2, an effect operating unit 3, a master adjustment unit 4, and an equalizer adjustment unit 5.

The microphone adjustment unit 2 includes operators for adjusting the output volume of a microphone (not illustrated) connected to the DJ mixer 1 and for starting and stopping effect processing performed by the effect operating unit 3. The microphone adjustment unit 2 further includes a jack for connecting headphones, through which a user monitors the volume of audio data output from the DJ mixer 1. The microphone adjustment unit 2 includes, for example, a headphone input/output jack, a headphone volume adjuster, a mixing adjuster, a master effect switcher and a master effect amount adjuster, a microphone switcher and a microphone volume adjuster, and a microphone equalizer adjuster.

The effect operating unit 3 includes operators for performing effect processing such as adding sound effects or special effects to input audio data. The effect operating unit 3 includes an effect switcher 31, a channel switcher 32, an effect time setter 33, an effect amount adjuster 34, and a display 35.

The effect switcher 31 includes a switch for selecting types of effect processing to be added to the audio data. In response to an operation of the switch, the effect switcher 31 selects effect processing, such as echo, delay, reverb, or flanger.

The channel switcher 32 includes an operator for selecting, from among a plurality of channels provided in the equalizer adjustment unit 5, a channel in which the audio data to be subjected to effect processing is input. In response to an operation of the operator, the channel switcher 32 switches the audio data to be subjected to effect processing.

The effect time setter 33 includes an operator for setting a time interval and the like used when performing the effect processing selected by the effect switcher 31. Details of the effect time setter 33 will be described later.

The effect amount adjuster 34 includes an operator for adjusting an added amount and a depth of an effect in the effect processing selected by the effect switcher 31. In response to an operation of the operator, the effect amount adjuster 34 adjusts the added amount and the depth of the effect in the effect processing.

The display 35 is a display element for making a user visually recognize the selected effect and BPM of the input audio data.

The master adjustment unit 4 includes operators for adding the effect outputted by the DJ mixer 1 and adjusting the entirety of the amplified audio data. The master adjustment unit 4 includes, for example, a master volume adjuster, a level indicator, a master volume balance adjuster, an equalizer switcher, a channel fader switcher, and a cross fader switcher.

The equalizer adjustment unit 5 includes operators for performing equalizer processing, for each channel, on the audio data input from music playback apparatuses connected to the DJ mixer 1. Specifically, the equalizer adjustment unit 5 includes a first adjustment unit 5A to a fourth adjustment unit 5D for respectively adjusting the four channels.

A music playback apparatus and a music operation apparatus are connected to each of the first adjustment unit 5A to the fourth adjustment unit 5D, and equalizer adjustment can be performed for each of the first adjustment unit 5A to the fourth adjustment unit 5D. Each of the first adjustment unit 5A to the fourth adjustment unit 5D includes, for example, an input switcher, an input channel volume adjuster, a channel level indicator, an adjuster for each frequency, and a channel fader. In addition, the equalizer adjustment unit 5 includes a cross fader and the like.

### Detailed Configuration of Effect Time Setter 33

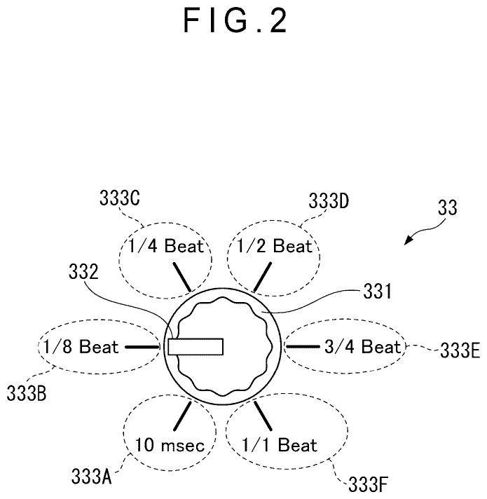

As illustrated in FIG. 2, the above-mentioned effect time setter 33 includes an operation knob 331, an adjustment position marker 332, and scales 333A to 333F.

The operation knob 331 is rotatably held on a casing of the effect time setter 33.

The adjustment position marker 332 is formed integrally with the operation knob 331, and a user can visually recognize an adjustment content when rotating the operation knob 331, on the basis of a positional relationship between the adjustment position marker 332 and the scales 333A to 333F.

The scales 333A to 333F, which are disposed on the casing of the effect time setter 33, each include a line segment corresponding to an adjustment position of the operation knob 331, and a unit of beat assigned to the line segment. The unit of beat may be printed on the casing or may be displayed on a display.

The scales 333A to 333F are associated with the time intervals in units of multiples of m/n beats. Each of “m” and “n” is any integer. In an example of FIG. 2, the scales 333A to 333F are associated with 10 milliseconds, ⅛ beat, ¼ beat, ½ beat, ¾ beat, and 1/1 beat, respectively. Details of the scales 333A to 333F will be described later.

The operation knob 331 of the effect time setter 33 is adjustable stepwise from the scales 333A to 333F. The stepwise adjustment is achieved, for example, by an engagement portion composed of a known latch and recess. In addition, the operation knob 331 is adjustable continuously in a range other than the scales 333A to 333F.

The effect time setter 33 can receive two types of operations by a user. The first type operation is for the user to adjust the operation knob 331 to any one of the scales 333A to 333F. In this operation, the user can roughly adjust the time interval set by the effect time setter 33, in units of multiples of m/n beats of the audio data.

The second type operation is for the user to continuously rotate the operation knob 331 in the range other than the scales 333A to 333F. In this operation, the user can set the time interval set by the effect time setter 33 in more detail in time units such as milliseconds.

### Functional Block Diagram of DJ Mixer 1

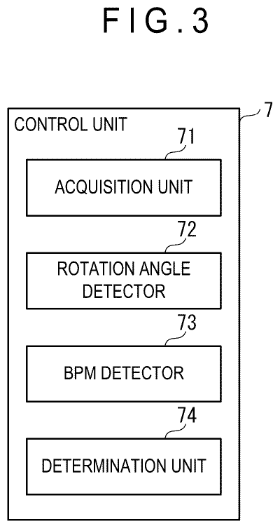

FIG. 3 illustrates a functional block diagram of a control unit of the DJ mixer 1. Portions related to the effect time setter 33 will be described below.

A control unit 7 for controlling the DJ mixer 1 performs control on the input audio data in response to an operation by a user on the various operators described with reference to FIG. 1. The control unit 7 includes an acquisition unit 71, a rotation angle detector 72, a BPM detector 73, and a determination unit 74.

The acquisition unit 71 acquires outputs of the various operators of the DJ mixer 1.

The rotation angle detector 72 detects a rotation angle of the operation knob 331 of the effect time setter 33, on the basis of an output of the effect time setter 33. Detection of the rotation angle is repeatedly performed at a predetermined cycle.

The BPM detector 73 detects BPM of the audio data to be subjected to effect processing. The BPM detection may be performed by any known method. The BPM detection is repeatedly performed at a predetermined cycle.

The determination unit 74 determines a time interval corresponding to each of the scales 333A to 333F depending on a BPM value detected by the BPM detector 73. Table 1 shows, as an example, the time intervals determined by the determination unit 74.

TABLE 1

| | 10 | | | | | |
|---|---|---|---|---|---|---|
| | msec | ⅛ Beat | ¼ Beat | ½ Beat | ¾ Beat | 1/1 Beat |
| BPM | 10 | 75 msec | 150 msec | 300 msec | 450 msec | 600 msec |
| 100 | msec | | | | | |
| BPM | 10 | 62.5 msec | 125 msec | 250 msec | 375 msec | 500 msec |
| 120 | msec | | | | | |

As shown in Table 1, for example, for the scale 333F associated with 1/1 beat, the determination unit 74 determines a time interval of 600 milliseconds when the BPM value detected by the BPM detector 73 is 100, and determines a time interval of 500 milliseconds when the BPM value detected by the BPM detector 73 is 120. Similarly, for example, for the scale 333D associated with ½ beat, the determination unit 74 determines a time interval of 300 milliseconds when the BPM value detected by the BPM detector 73 is 100, and determines a time interval of 250 milliseconds when the BPM value detected by the BPM detector 73 is 120.

In other words, the determination unit 74 determines the time interval corresponding to each scale to be shorter as the BPM value detected by the BPM detector 73 increases, and determines the time interval corresponding to each scale to be longer as the BPM value detected by the BPM detector 73 decreases. Accordingly, the time interval associated with a predetermined rotation angle of the operation knob 331 differs depending on the BPM value.

Further, the determination unit 74 determines the time interval corresponding to the range other than the scales 333A to 333F in accordance with the respective time intervals corresponding to the scales adjacent to the range. For example, for a range between the scale 333C associated with ¼ beat and the scale 333D associated with ½ beat, when the BPM value detected by the BPM detector 73 is 100, the determination unit 74 determines a time interval of 150 milliseconds to 300 milliseconds in association with the BPM value, and when the BPM value detected by the BPM detector 73 is 120, the determination unit 74 determines a time interval of 125 milliseconds to 250 milliseconds.

In the range other than the scales 333A to 333F, the time interval associated with each unit rotation angle may be changed linearly or may be changed functionally.

The change in time interval in the range other than the scales 333A to 333F may be settable by a user.

According to the effect time setter 33 described above, when a user rotates the operation knob 331 to any one of the scales 333A to 333F, it is possible to set the time interval in units of multiples of m/n beats of the audio data. In addition, according to the effect time setter 33, when the user continuously rotates the operation knob 331 in the range other than the scales 333A to 333F, it is possible to set the time interval in milliseconds.

Control Method in Response to Operation on Effect Time Setter 33

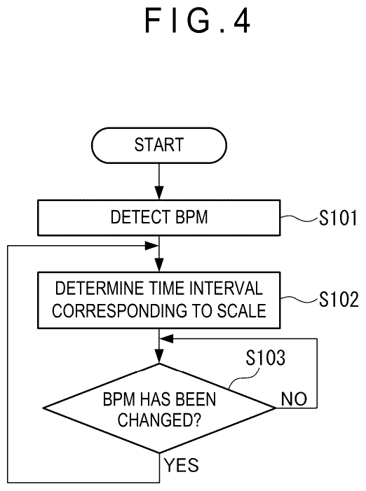

FIG. 4 is a flowchart of a control method executed by the control unit 7.

The BPM detector 73 detects BPM of the audio data (Step S101), and the determination unit 74 determines the time interval corresponding to each scale depending on the BPM (Step S102).

Then, when it is judged that the BPM has been changed (Step S103: YES), the determination unit 74 again determines the time interval corresponding to each scale (Step S102).

That is, when the BPM of the audio data to be subjected to effect processing is changed, the determination of the time interval is performed by the determination unit 74. Accordingly, the time interval set by the effect time setter 33 can always be optimized in accordance with the BPM.

### Advantageous Effects of Exemplary Embodiment(s)

According to the DJ mixer 1 according to the exemplary embodiment described above, the following advantageous effects can be achieved.

The DJ mixer 1 is adjustable stepwise to a plurality of predetermined scales, and is provided with the effect time setter 33 that includes the rotary operator for setting a time interval used when adding sound effects or special effects to the audio data. The control unit 7 of the DJ mixer 1 includes the rotation angle detector 72 and the determination unit 74. The rotation angle detector 72 detects the rotation angle of the operation knob 331, which is the rotary operator of the effect time setter 33. The determination unit 74 determines the time intervals corresponding to the scales 333A to 333F in units of multiples of m/n beats of the audio data, depending on the BPM of the audio data.

With such a configuration, the time intervals can be set in units of multiples of m/n beats of the audio data to be subjected to effect processing, and the scales of the effect time setter 33 can be optimized in accordance with the BPM of the audio data. Thus, in setting the time intervals related to effect processing, simple and intuitive operations become possible, and improvement in setting flexibility can be expected.

According to the exemplary embodiment, the operation knob 331, which is the rotary operator of the effect time setter 33, can be continuously adjusted in the range other than the plurality of predetermined scales 333A to 333F, and the determination unit 74 determines the time interval corresponding to the range in accordance with the respective time intervals corresponding to the scales adjacent to the range.

With such a configuration, by operating the effect time setter 33 that is a single operator, a user can seamlessly and smoothly perform both setting in units of multiples of m/n beats of the audio data and continuous setting in ranges between those units. Thus, simple and intuitive operations by the user become possible, and improvement in setting flexibility can be expected.

According to the exemplary embodiment, the determination unit 74 determines the time interval corresponding to each scale to be shorter as the BPM value increases, and determines the time interval corresponding to each scale to be longer as the BPM value decreases. Thus, the time intervals set by the effect time setter 33 can always be optimized in accordance with the BPM.

### Modification(s) of Exemplary Embodiment(s)

In the above exemplary embodiment, the effect time setter 33 illustrated in FIG. 2 is merely an example, and the exemplary embodiment is not limited thereto. For example, the scales 333A to 333F disposed symmetrically with respect to the center of the operation knob 331 are illustrated in the example in FIG. 2. However, the scales may be disposed asymmetrically. Further, for example, the six scales, i.e., the scales 333A to 333F, are illustrated in FIG. 2. However, five or fewer, or seven or more scales may be provided.

The time intervals determined by the determination unit 74 shown in Table 1 are merely an example, and the exemplary embodiment is not limited thereto. For example, the time intervals associated with the respective scales are not limited to the example in Table 1. The time interval of 10 milliseconds is associated with the scale 333A in the example in Table 1, but another time interval, such as 1/16 beat, may be associated therewith.

Further, a part or all of the time intervals determined by the determination unit 74 depending on the BPM may be settable by a user.

The effect time setter 33 including the rotary operator is exemplified in the above exemplary embodiment. However, the invention is not limited thereto. For example, the invention can be applied in a similar manner to an acoustic apparatus including a slidable operator that moves linearly, which is used in a fader and the like. In the case of a plurality of predetermined scales of the slide operator, the time intervals corresponding to the scales may be determined in units of multiples of m/n beats of the audio data, depending on the BPM of the audio data.

The acoustic apparatus having the functions as described above is not limited to the acoustic apparatus exemplified in each of the above exemplary embodiments, and may be, for example, a mixer or a DJ controller equipped with mixer functions. The invention may be applied to computers, smartphones, or tablet terminals that run DJ applications. In such cases, even in an acoustic apparatus including no rotary operator member, similar effects can be achieved.

In addition, the invention may be applied not only to DJ equipment and DJ applications, but also to music applications, streaming services using the Internet, and the like. In such cases, the invention is applicable, for example, to automatic playback using a playlist or the like.

In each of the above exemplary embodiments, a four-channel acoustic apparatus is described, but for example, similar functions can also be achieved in a two-channel acoustic apparatus. The invention is not limited to applications in DJ equipment, and is also applicable to typical mixers and electronic musical instruments, and further to acoustic apparatuses such as Digital Audio Workstation (DAW) and Desk Top Music (DTM).

The preferred exemplary embodiment of the invention is described above in detail with reference to the attached drawings. However, the scope of the invention is not limited to the exemplary embodiment. It would be apparent to those skilled in the art to which the invention pertains that various modifications and revisions are conceivable within the technical idea recited in the appended claims, and it is understood that such modifications and revisions are naturally within the technical scope of the invention.

### EXPLANATION OF CODES

1 . . . . DJ mixer, 2 . . . microphone adjustment unit, 3 . . . effect operating unit, 4 . . . master adjustment unit, 5 . . . equalizer adjustment unit, 5A . . . first adjustment unit, 5D . . . fourth adjustment unit, 7 . . . control unit, 31 . . . effect switcher, 32 . . . channel switcher, 33 . . . effect time setter, 34 . . . effect amount adjuster, 35 . . . display, 71 . . . acquisition unit, 72 . . . rotation angle detector, 73 . . . . BPM detector, 74 . . . determination unit, 331 . . . operation knob, 332 . . . adjustment position marker, 333A, 333B, 333C, 333D, 333E, 333F . . . scale.

1-5. (canceled)

6. An acoustic apparatus, comprising:
a rotary operator configured to be adjustable stepwise to a plurality of predetermined scales and configured to set a time interval used when adding a sound effect or a special effect to audio data;
a detector configured to detect a rotation angle of the rotary operator; and
a determination unit configured to determine the time interval corresponding to each of the scales in units of multiples of m/n beats of the audio data, depending on BPM of the audio data.

7. The acoustic apparatus according to claim 6, wherein
the rotary operator is configured to be continuously adjustable in a range other than the plurality of predetermined scales, and
the determination unit is configured to determine the time interval corresponding to the range in accordance with the time intervals corresponding to the scales adjacent to the range.

8. The acoustic apparatus according to claim 6, wherein the determination unit is configured to determine the time interval corresponding to each of the scales to be shorter as a value of the BPM increases, and determine the time interval corresponding to each of the scales to be longer as the value of the BPM decreases.

9. A control method of an acoustic apparatus, the control method comprising:
detecting a rotation angle of a rotary operator, the rotary operator being adjustable stepwise to a plurality of predetermined scales and configured to set a time interval used when adding a sound effect or a special effect to audio data; and
determining the time interval corresponding to each of the scales in units of multiples of m/n beats of the audio data, depending on BPM of the audio data.

10. A non-transitory computer-readable medium storing a program causing a computer to operate as an acoustic apparatus, the acoustic apparatus comprising:
a detector configured to detect a rotation angle of a rotary operator, the rotary operator being adjustable stepwise to a plurality of predetermined scales and configured to set a time interval used when adding a sound effect or a special effect to audio data; and
a determination unit configured to determine the time interval corresponding to each of the scales in units of multiples of m/n beats of the audio data, depending on BPM of the audio data.
